(19) United States
(12) Patent Application Publication
(10) Pub. No.: US 2018/0143957 A1
(43) Pub. Date: May 24, 2018

(54) USING FORMAT PATTERNS FOR NUMERIC FORMATTING

(71) Applicant: BUSINESS OBJECTS SOFTWARE LIMITED, Dublin (IE)

(72) Inventors: Marcin Jakubik, Saint-Cloud (FR); Alexandre Fortin, Paris (FR)

(21) Appl. No.: 15/355,356

(22) Filed: Nov. 18, 2016

(51) Int. Cl. G06F 17/24; G06F 17/30

(52) U.S. Cl. CPC G06F 17/243; G06F 17/30569; G06F 17/30339; G06F 17/245

(57) ABSTRACT

A system, computer-readable medium, and method including presenting a first value, the first value being a member of a category of values; receiving a user-edited value for displaying the first value in a desired format; determining a best guess formatting formula corresponding to the user-edited value; and applying the formatting formula to other values belonging to the category including the first value.

### BACKGROUND

Some formats of numbers that might be expressed on spreadsheets, reports, and other documents can be quite complex, since they may include one or more symbols in addition to numbers (e.g., currency identifiers, commas, periods, etc.). But, some numeric formats can be very simple. However, a spreadsheet, report, and other documents can include a mix of simple and complex number formats. It is known to use a formatting programming language to accurately and precisely define the various formats for numbers. However, such languages are complex and beyond the understanding of all of the individuals that might want to modify a number's displayed format.

### BRIEF DESCRIPTION OF THE DRAWINGS

FIG. 1 is an illustrative schematic diagram of an example system;

FIGS. 2A-2C are illustrative examples of outward views of user interfaces in some embodiments herein;

FIG. 3 is an example embodiment of an illustrative flow diagram of a process herein;

FIGS. 4A-4E are illustrative examples of outward views of user interfaces in some embodiments herein;

FIG. 5 is an example embodiment of an illustrative flow diagram of numeric formatting process in some embodiments herein;

FIG. 6 is a schematic block diagram of an architecture framework to facilitate some embodiments of the present disclosure; and

FIG. 7 is a block diagram of an apparatus, according to some embodiments.

### DETAILED DESCRIPTION

The following description is provided to enable any person in the art to make and use the described embodiments. Various modifications, however, will remain readily apparent to those in the art.

As used herein, the term “Format pattern” refers to a numeric or date value to which the user's changes are interpreted, not as value changes but as display changes. The format pattern is allowed to be ambiguous.

As used herein, “Format guesser” refers to an algorithm that takes as input a format pattern and outputs an unambiguous “format formula”. If not possible, the format guesser indicates that the pattern cannot be transformed into a formula.

As used herein, “Format formula” refers to a text string (formula) composed of characters that unambiguously define how to format any given value.

As used herein, “Formatting language” refers to a set of rules that unambiguously define the behavior of a format formula when applied to a value.

As used herein, “Formatter” refers to a tool that takes as input a format formula and a value, and outputs a formatted value. There is one formatter for each format formula. Each formatter acts as the link between the formula and the set of values that might be formatted.

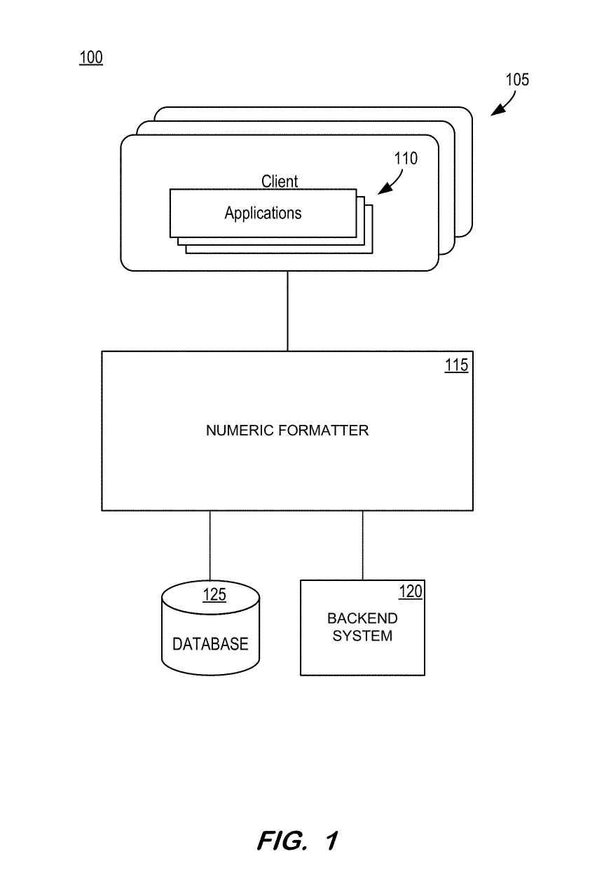

FIG. 1 is an illustrative block diagram of an architecture or system 100, in one example. Examples of some embodiments of the present disclosure are not limited to the particular architecture 100 shown in FIG. 1. System 100 includes one or more client devices 105 running one or more applications 110. Applications 110 may, in some embodiments, include a suite of different software applications having, at least to some extent, related functionality, similar user interfaces, and some ability to exchange data with each other. Applications 110 may include different software applications that support the operations and process of an organization. In some embodiments, one or more of the applications 110 may include functionality or a tool to generate a formatting formula for a particular value. The generated formatting formula may be stored to a memory and subsequently used to format other values similar to the particular value in a like manner. In some embodiments, values may be deemed to be similar if they belong to a same category of values. In some instances, the values (both the particular value and the other similar values) may be a set of values in a database table, a data warehouse, a report, and other entities. In some instances, the category may be a measure in a data set. In another instance, the category may relate to a dimension of the data set.

System 100 includes a numeric formatter service or server 115. In some embodiments, a functionality or service for formatting different configurations of numbers, dates, and text strings may be deployed as a cloud-based service, whereas in some other embodiments system 100 may include a client-server architecture. System 100 may encompass both scenarios. In the instance system 100 includes a server at 115, the devices at 105 may be client devices running applications as discussed above. If an instance of a system includes a cloud-based server at 115, the devices at 105 may execute a browser that is used by a user to interface with service 115.

System 100 further includes a backend system that can execute, and in some instances, automatically, executable code or instructions to perform one or more numeric formatting processes. In some aspects herein, a user may provide an indication of how they would like a value to be displayed and the functionality of the tool, as implemented in an application 110 and/or server or service 115, may operate in cooperation with the processing of a backend system 120 to automatically generate a formatting formula corresponding to the user-supplied numeric value (a “format pattern”), generally without further input or intervention from the user.

In one example, a client 105 executes an application 110 to present a numeric formatting tool or functionality via a user interface (UI) to a user on a display of client 105 including a first numeric value. The user manipulates UI elements within the UI to edit the first numeric value and otherwise indicate a desired display configuration for the first numeric value, where a server or service 115 embodying the numeric formatter operates, in cooperation with backend system 120 and database 125 to generate a formatting formula accurately corresponding to the user's edited version of the first value. The numeric formatter's results (e.g., the formatting formula) may be saved and applied to format other values similar to the first value so that those other values may also be displayed or presented in the format desired by the user.

Database 125 may comprise any data source or sources that are or become known. Database 125 may comprise a relational database, a HTML document, an eXtendable Markup Language (XML) document, or any other data storage system storing structured and/or unstructured data files. The data of database 125 may be distributed among several data sources. Embodiments are not limited to any number or types of data sources.

Database 125 may implement an “in-memory” database, where a full database is stored in volatile (e.g., non-disk-based) memory (e.g., Random Access Memory). The full database may be persisted in and/or backed up to fixed disks (not shown). Embodiments herein are not limited to an in-memory implementation. For example, data may be stored in Random Access Memory (e.g., cache memory for storing recently-used data) and other forms of solid state memory and/or one or more fixed disks (e.g., persistent memory for storing their respective portions of the full database).

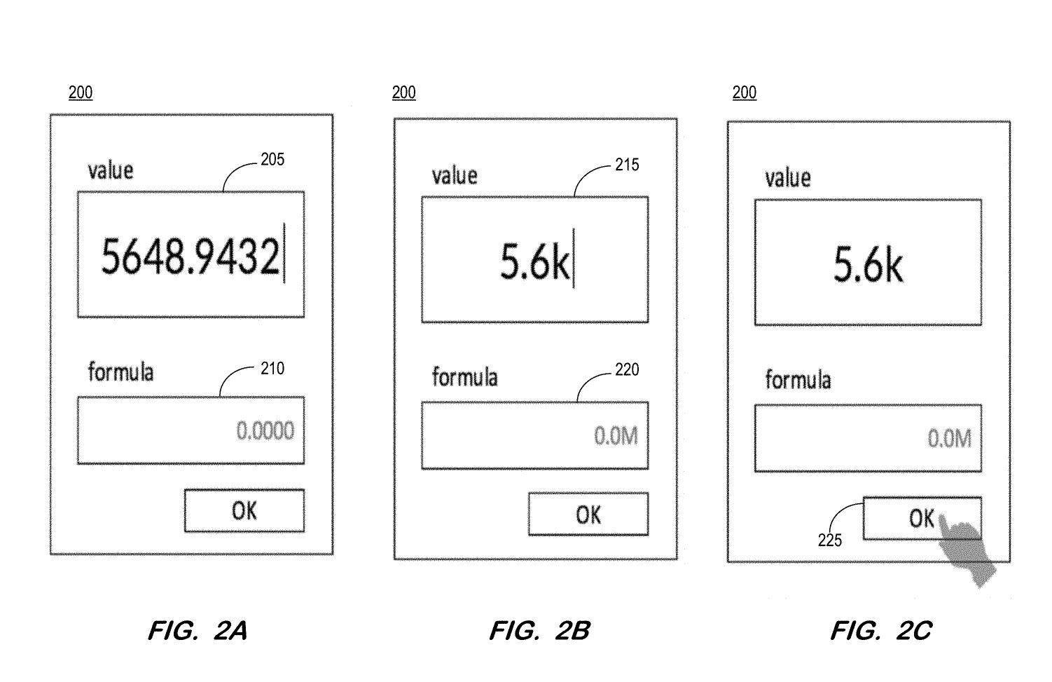

FIGS. 2A-2C are outward views of an example user interface (UI) 200, illustrating different aspects of some embodiments of processes and systems disclosed herein. In some regards, FIGS. 2A-2C illustrate an embodiment wherein a user can type or otherwise indicate a value they expect or desire to see displayed for a given raw or first value. The raw value may be derived from a database table or other data structure comprising a data set. In some regards, the processes and systems in some embodiments herein may relate to generating, via a calculated guess by the system, a formatting formula and applying it to a plurality values so that each of the plurality of values can be displayed in the configuration desired by the user. That is, some embodiments relate to formatting a plurality of values, as opposed to singular values. In this manner, some of the embodiments disclosed herein may be leveraged to efficiently modify or change the way multiple different numeric values can be displayed based on a formatting formula generated based on a representative first numeric value. In some instances, the numeric value can be any text string including alpha-numeric and other symbols.

In FIG. 2A, a system, service, or application embodying aspects disclosed herein displays UI 200. UI 200 includes a presentation of a first value 205 (i.e., “5648.9432”). The first value may be derived from a data set such as, for example, a database including a plurality of data tables, where instances of the data tables may relate to real-world entities (e.g., products, processes, etc.) without limit or constraint. In some embodiments, the first value 205 belongs to a category of values, as characterized, for example, by a data schema of the database. In some instances, the category may be a measure of the database. In addition to the value presented at 205, the UI of FIG. 2A includes display of the corresponding formatting formula 210 (i.e., “0.0000”) for the first value 205.

It is noted that the formula shown at 210 may be defined by a programmatic formatting language that defines in specific language and syntax the formula for repeatedly and accurately formatting the value 205, and other values similar thereto.

Having been presented with value 205, a user wants to see that value displayed in a different format. Whether a matter of preference or to accommodate some other consideration (e.g., formatting more favorable for a report, presentation, etc.), the user in the present example types an edited version of the 205 value. In this example, the user types “5.6 k” in the value field UI element at 215 (e.g., over/in place of the “5648.9432” value), as illustrated in FIG. 2B. The “5.6 k” is the user-edited value representing the configuration or way the user wants to see the first value (“5648.9432”) displayed. In some embodiments, the system, service, server, or application (generally, the “system”) implementing the system and processes depicted in FIGS. 2A-2C generates the formula 220 that it determines to correspond to the user-edited value 215. In some instances, the formula 220 is presented and updated as the user enters value 215 in the UI in FIG. 2B. That is, in response to the user entering value 215, the system updates the formula shown at 220. In this example, the user entered symbol “k” is represented by the formatting language known and used by the system by the symbol “M”.

FIG. 2C illustrates a mechanism for the user to accept and/or confirm the formula 220 determined or “guessed” by the system in FIG. 2B accurately corresponds to the user-edited value 215. In FIG.2C, the user touches the UI “OK” button to accept the proposed formula 220.

As illustrated by FIGS. 2A-2C, the system automatically generates the formula 220 corresponding to the user-edited value 215, without the user needing to specify, or even know, any formatting language and/or rules relating thereto. It might be helpful, in the example of FIGS. 2A-2C, for the user to know that a value 215 including the symbol “k” is represented by the symbol “M” by the system. However, the system did not rely on the user's knowledge or additional user input to determine the formula 220.

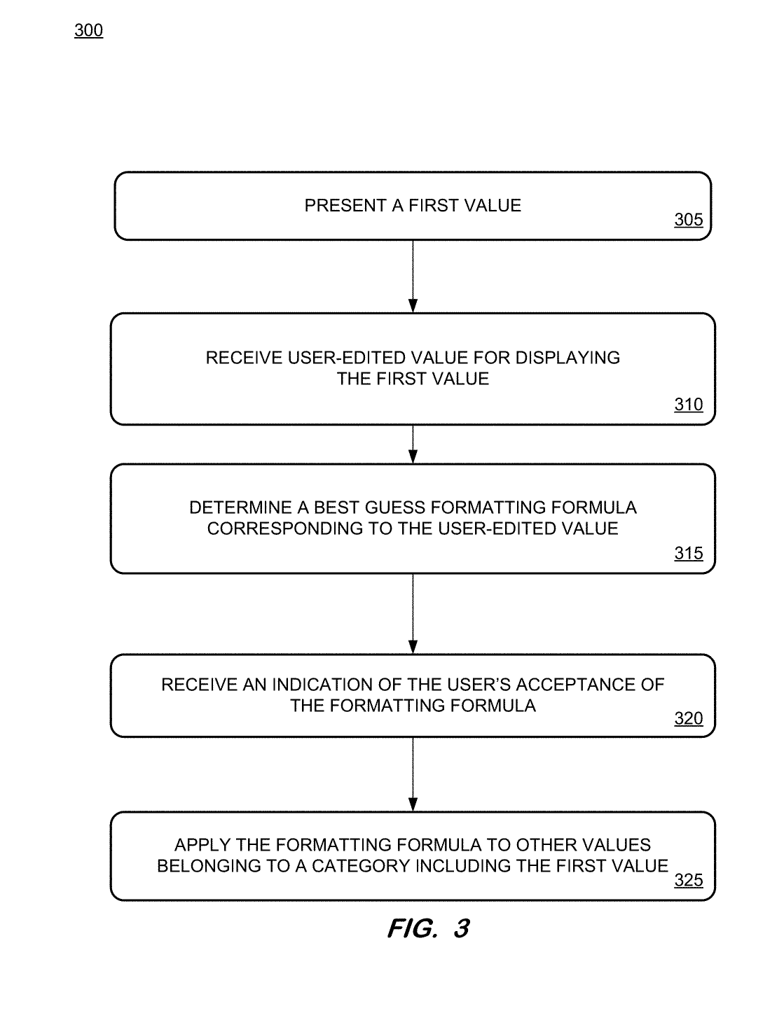

FIG. 3 is an illustrative depiction of an example process 300. Process 300 may be implemented using a system including some, all, or none of the aspects shown in FIG. 1. At an operation 305, the system may present a first value to the user via a UI (e.g., FIG. 2A, 205). The user may, in reply, edit the first value to indicate the way they want to see it displayed. As such, the system receives the user-edited value (e.g., FIG. 2B, value 215) for displaying the first value at operation 310.

Operation 315 includes the system, service, application, functionality, device, or tool herein determining a “best guess” formatting formula (FIG. 2B, formula 220) corresponding to the user-edited value in response to the receiving operation 310. Continuing with process 300, the system receives, at operation 320, an indication of the user accepting and confirming that the formatting formula generated at operation 315 is acceptable (FIG. 2C, user selection of “OK” at 225). Upon acceptance of the proposed formula generated at operation 315, the system saves a record of the formatting formula so that it may be used to format other values similar to the first value serving as the basis for the determination and generation of the formatting formula. At operation 325, the formatting formula is applied to other values belonging to a category including the first value. The category may, in some instances, refer to a measure, although it may relate to a dimension of a data set (or even other categories and groupings of values). In some embodiments, a category may correspond to a column in a database, where all values in the column have the same data type, and all values have the same meaning (i.e., a “price”).

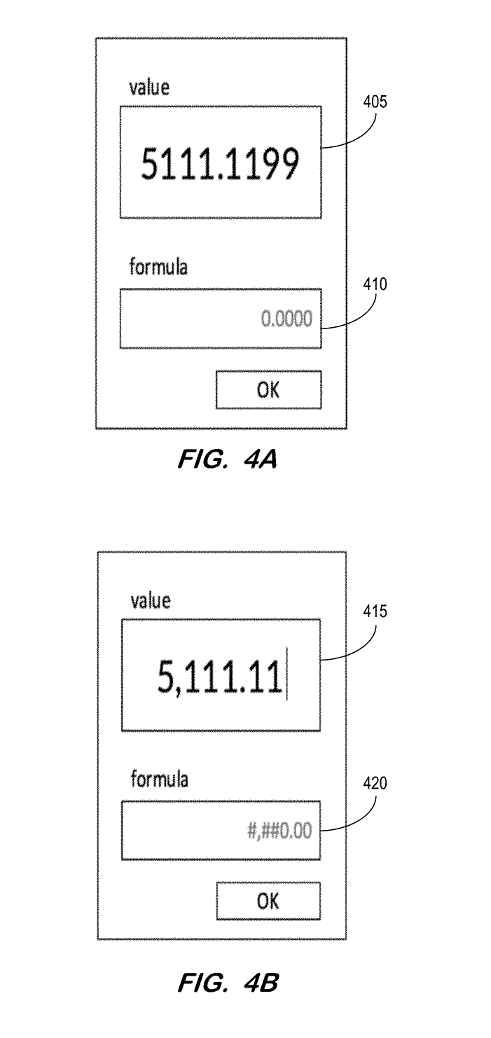

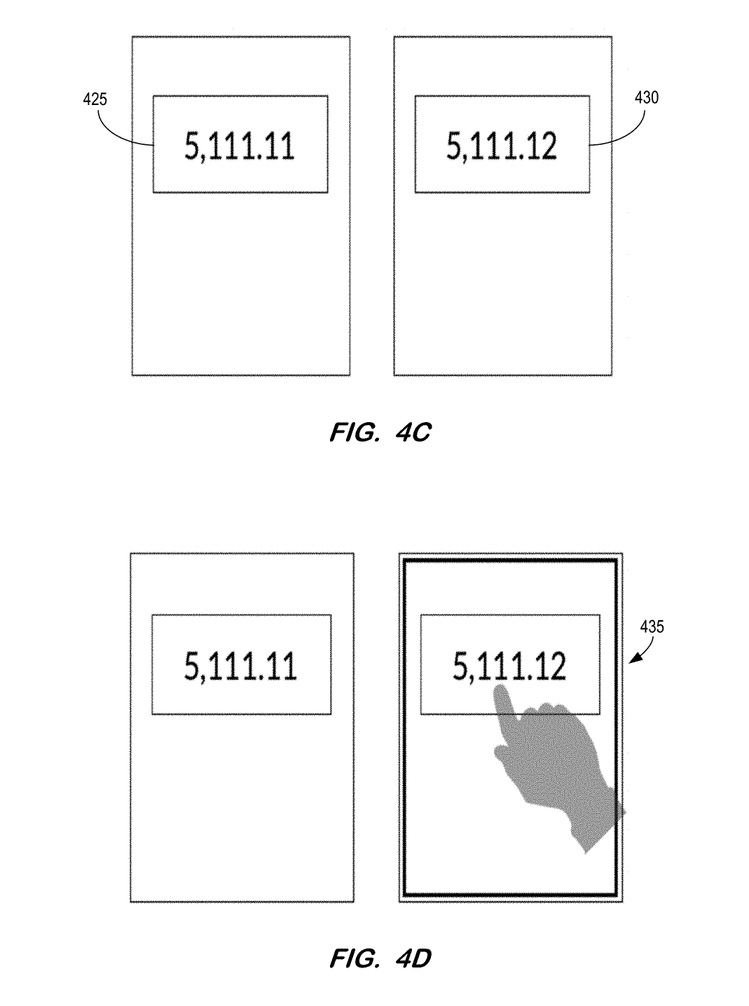

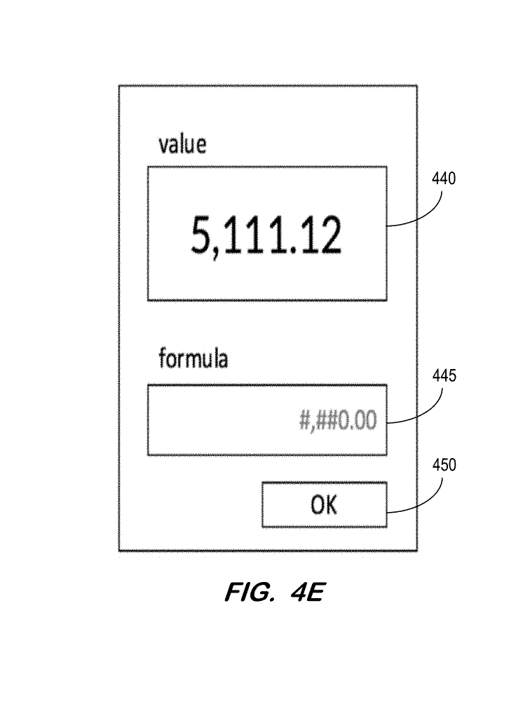

FIGS. 4A-4E are depictions of outward views of example UIs, in accordance with some embodiments herein. In particular, FIGS. 4A-4E relate to some aspects of processes and systems disclosed herein, including an illustrative example where there may be some ambiguity in a user-edited value that a user may provide to a system to indicate how they would like to see a value displayed.

In FIG. 4A, a system, service, or application embodying aspects disclosed herein displays a UI including a presentation of a first value 405 (i.e., “5111.1199”). The first value might be derived from a data set such as a database including a plurality of data tables. In some embodiments, the first value 405 belongs to a category of values, as characterized, for example, by a data schema of the database. In some instances, the category may be a measure of the database. The UI in FIG. 4A also includes a presentation of the corresponding formatting formula 410 (i.e., “0.0000”) for the first value 405.

In the example of FIGS. 4A-4E, a user wants to see the first value displayed in a different format. Whether a matter of preference or to accommodate some other consideration (e.g., formatting more favorable for a report, presentation, etc.), the user in the present example types an edited version of the 405 value by adding a comma and deleting a number of decimal places, as shown in the user-edited value 415 in FIG. 4B. In this example, the user types “5,111.11” in the value field UI element at 415 (e.g., over/in place of the “5111.1199” value. The “5,111.11” is the user-edited value representing the configuration or way the user wants to see the first value (“5111.1199”) displayed.

In some embodiments, the system, service, server, or application implementing the system and processes depicted in FIGS. 4A-4E generates the formula 420 that it determines to correspond to the user-edited value 415. In some instances, the formula 420 is presented and updated as the user enters value 415 in the UI. In this example, the “0” symbol defines a required digit and the “#” symbol represents an optional digit.

However, the system recognizes an ambiguity in attempting to generate a formatting formula that accurately reflects the user's desired display formatting. In particular, the first value “5111.1199” may be rounded-up or rounded-down to, as indicated by the user-supplied user-edited value 415, reduce the number of displayed digits to the right of the decimal. Given this example of an ambiguity, of which there may be other instances, the system presents a plurality (i.e., at least two) of alternative choices for the formatting formula to correspond to the user-edited value 415, as shown in FIG. 4C. In FIG. 4C, the system presents the two alternative choices 425, 430 for the present example based on the first value 405 and the user-edited value 415. The values 425 and 430 represent rounding-down and rounding-up of the first value to get the user-edited value 415, respectively.

The user selects one of the presented alternative choices, 425 or 430, to indicate their decision regarding which choice accurately reflects what they want to see displayed given the first value 405. In the present example, the user selects the value shown at 430 by touching the touch-enabled screen displaying the alternative choices, as shown in FIG. 4D at 435. In other implementations, other methods of interacting with a system or device to provide an indication of a user selection might be used such as, for example, a “drag and drop” operation, a voice input, etc.

FIG. 4E shows the UI presentation including the user's choice of corrected user-edited value 440. FIG. 4E further shows the formatting formula 445 determined and generated based on the corrected user-edited value 440, as well as a UI element/mechanism (e.g., “OK” button 450) for the user to indicate and confirm the proposed formatting formula 445 is an acceptable and appropriate formula to accurately format the subject values as the user wishes to see them displayed.

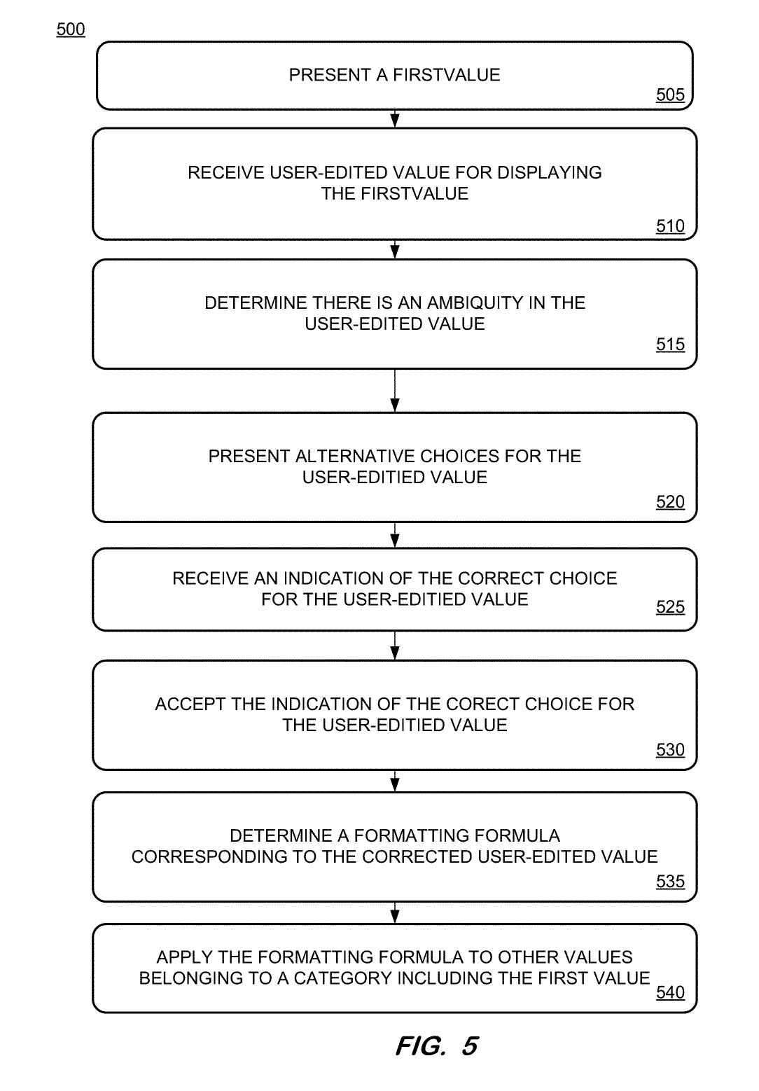

FIG. 5 is an illustrative depiction of an example process 500. Process 500 may be implemented using a system including some, all, or none of the aspects shown in FIG. 1. Process 500 may include at least some of the aspects illustrated in FIGS. 4A-4E. At an operation 505, the system may present a first value to the user via a UI (e.g., FIG. 4A, 405). The user may, in reply, edit the first value to indicate how they want to see it displayed. As such, the system receives the user-edited value (e.g., FIG. 4B, value 415) for displaying the first value at operation 510. In the present example of process 500, the user-edited value is recognized as being ambiguous at operation 515. Since the system cannot, with full confidence, propose a formatting formula that will display the first value (and other similar values) as desired by the user, the system proceeds to present alternative choices to the user for the user-edited value, as stated in operation 520 (e.g., FIG. 4C, 425, 430). At operation 525, the system receives an indication of the correct choice for the user-edited value (e.g., FIG. 4D, 435).

Continuing with process 500 at operation 530, the system accepts the user-supplied indication of the correct choice for the user-edited value and determines a formatting formula based on the corrected user-edited value at operation 535.

At operation 540, the formatting formula is applied to other values belonging to a category including the first value. The category may, in some instances, refer to a measure, a dimension of a data set, and other categories and groupings of values.

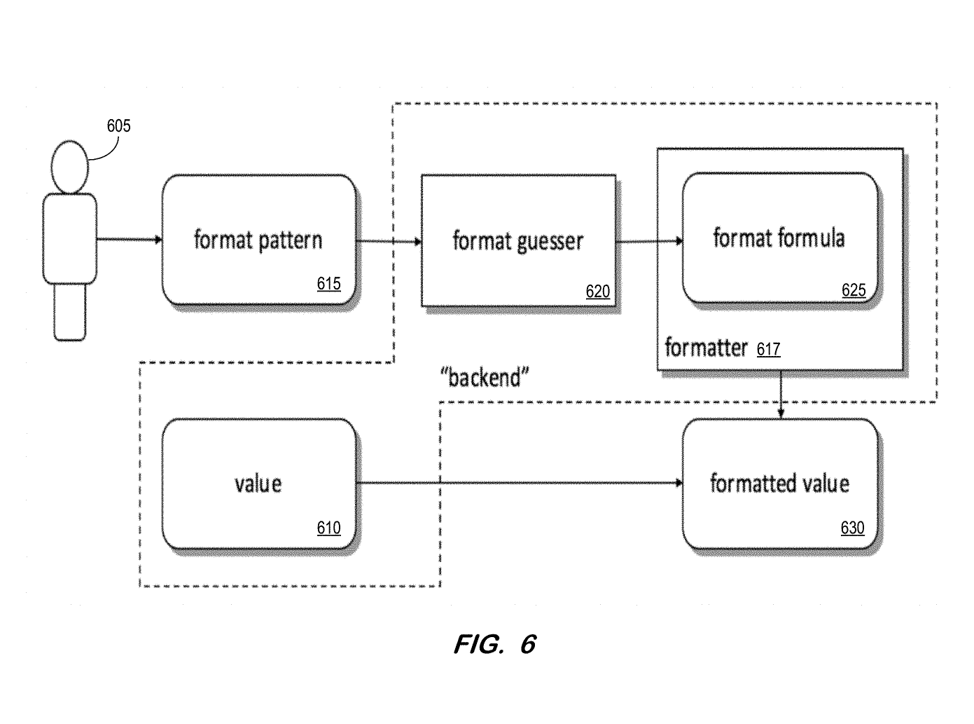

FIG. 6 is an example schematic block diagram for a system 600 that may support and facilitate some embodiments herein. FIG. 6 depicts a user 605 that may interface and interact with system 600. Consistent with some aspects of the foregoing disclosure herein, a (first) value 610 may be presented to user 605. The user may provide a format pattern (i.e., a user-edited version of the value representing the way the user wants to see the value displayed) to the system. Based on the format pattern provided by the user for the value 610, the system guesses the formatting corresponding to the user-supplied format pattern 615 by format guesser 620 and formatter 617 generates the formatting formula 625 that can accurately format the given value into the format the user wants. The format formula 625 is saved in a record in a memory accessible to the system, be it a local, a remote, a cloud-based, or a distributed storage facility, instance, or service. The format formula may be saved to, for example, apply it to a plurality of values in a data set, database table column, or other data constructs.

It is noted that in some embodiments, the user-supplied format pattern 615 is not saved or stored. Instead, when a user may request a formatted value from the system, the system applies the saved format formula 625 to the particular value to (re-)generate the formatted value.

In the example above, we assume that the characters typed by the user are unambiguous. However, many formats may not be guessable. If the user's input results in two possibilities, we propose to use an auto-correction paradigm to resolve them.

As used herein, auto-correction is an example of a user experience paradigm in which what the user types is not what appears on screen. For example, the user may type “monday”, but what is displayed is “Monday”. In some embodiments, the auto-correct result is non-intrusive because it is similar/close to the original input (e.g., monday˜Monday; the˜The); it may be possible to revert back to what was actually typed (i.e., this aspect may work in multiple states such as, for example, a first-try correction, then a second-try force); might sometimes be animated or highlighted to draw attention to the change; and may be presented as an opt-in or opt-out choice during typing. As such, some embodiments that include an auto-correction feature also permit a user to override the automatic corrections. In this manner, the user might retain the ability to ultimately choose the format they want.

In some embodiments, a number of symbols may be recognized by a format guesser or other component herein to generate a formatting formula. Table 1 includes a number of example symbols and their meaning in the context of the present disclosure. It is noted that other, more, fewer, and alternative symbols maybe used by some embodiments.

TABLE 1

| Symbol | Meaning |
|---|---|
| . | decimal |
| , | thousands separator |
| − | minus sign |
| $ | dollar sign |
| € | euro sign |
| any currency symbol with | the specified currency character |
| a Unicode code point | |
| % | percent |
| ° | degrees |
| ′ | feet |
| ″ | inches |

In some embodiments, a number of tokens may be recognized by a format guesser or other component herein to generate a formatting formula. Tokens are defined based on the symbol and their specific position in a text screen or other value.
Table 2 includes a number of example tokens and their meaning in the context of the present disclosure. It is noted that other, more, fewer, and alternative tokens maybe used by some embodiments.

TABLE 2

| Token | The user types . . . | Guessed formula |
|---|---|---|
| . | 6.5 | 0.0 |
| , | 1,234 | #,##0 |
| − | −123 | 0;−0 |
| $ | $8 | $0 |
| € | 8€ | 0€ |
| currency | any currency symbol with a | 0<symbol> |
| symbol | Unicode code point | |
| % | 40% | 0% |
| ° | 360° | 0° |
| ′ | 40′ | 0′ |
| ″ | 40″ | 0″ |

In some embodiments, a system, service, server, or application implementing some aspects of the present disclosure may include an auto-correct feature wherein user inputs are automatically corrected as the user enters an ambiguous entry. The auto-correct feature may be invoked automatically (or according to a setting) if there is a user ambiguity.

In some aspects, a locale of a system or user may be taken into consideration, since symbols, words, and number formatting may differ in different countries, jurisdictions, contexts, and societies. Localization can render some symbols ambiguous. For example, a period (.) can be a decimal separator or a thousands separator, depending on locale.

If the user's current locale is known to the format guesser, the guesser can condition its interpretation on this locale. For example, instead of interpreting a comma (,) as a thousands separator, the system can interpret the abstract <THOUSANDS-SEPARATOR> as a thousands separator. The definition of <THOUSANDS-SEPARATOR> would be contained in the locale object.

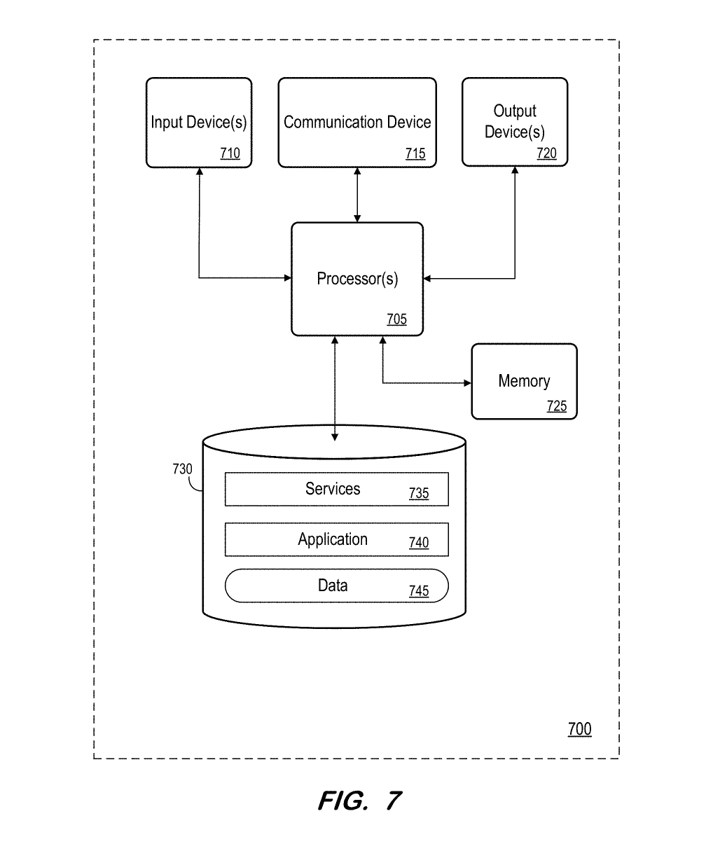

FIG. 7 is a block diagram of apparatus 700 according to some embodiments. Apparatus 700 may comprise a computing apparatus and may execute program code to perform any of the functions described herein. Apparatus 700 may comprise an implementation of server supporting an application (e.g., 110), a service 115, and a backend 120 of FIG. 1 in some embodiments. Apparatus 700 may include other unshown elements according to some embodiments.

Apparatus 700 includes processor 705 operatively coupled to communication device 715, data storage device 730, one or more input devices 710, one or more output devices 720, and memory 725. Communication device 715 may facilitate communication with external devices, such as a reporting client, or a data storage device. Input device(s) 710 may comprise, for example, a keyboard, a keypad, a mouse or other pointing device, a microphone, knob or a switch, an infra-red (IR) port, a docking station, and/or a touch screen. Input device(s) 710 may be used, for example, to enter information into apparatus 700. Output device(s) 720 may comprise, for example, a display (e.g., a display screen) a speaker, and/or a printer.

Data storage device 730 may comprise any appropriate persistent storage device, including combinations of magnetic storage devices (e.g., magnetic tape, hard disk drives and flash memory), optical storage devices, solid state storage devices, Read Only Memory (ROM) devices, etc., while memory 725 may comprise Random Access Memory (RAM), Storage Class Memory (SCM) or any other fast-access memory.

Services 735 and application 740 may comprise program code executed by processor 705 to cause apparatus 700 to perform any one or more of the processes described herein (e.g., 200, 300). Embodiments are not limited to execution of these processes by a single apparatus.

Data 745 (either cached or a full database) may be stored in volatile memory such as memory 725. Data storage device 730 may also store data and other program code and instructions for providing additional functionality and/or which are necessary for operation of apparatus 700, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

1. A system comprising:
a memory storing processor-executable instructions; and
a processor to execute the processor-executable instructions to cause the system to:
present a first value to a user, the first value being a member of a category of values;
receive a user-edited value for displaying the first value in a desired format;
determine a best guess formatting formula corresponding to the user-edited value;
saving a record of the formatting formula corresponding to the user-edited value; and
apply the formatting formula corresponding to the user-edited value to other values belonging to the category including the first value.

2. The system of claim 1, wherein the first value is one of a numeric value and a date representation.

3. The system of claim 1, wherein the processor is to further execute processor-executable instructions to cause the system to receive, prior to the applying of the formatting formula, an indication of a user's acceptance of the formatting formula.

4. The system of claim 1, wherein the first value and the other values are derived from a database table.

5. The system of claim 1, wherein the category is one of a measure and a dimension of a database table.

6. The system of claim 1, wherein the processor is to further execute processor-executable instructions to cause the system to store the formatting formula in a memory store.

7. A system comprising:
a memory storing processor-executable instructions; and
a processor to execute the processor-executable instructions to cause the system to:
present a first value to a user, the first value being a member of a category of values;
receive a user-edited value for displaying the first value in a desired format;
determine there is an ambiguity in the user-edited value;
present at least two alternative choices for the user-edited value;
receive an indication of a correct choice for the user-edited from a user;
determine a formatting formula corresponding to the corrected user-edited value;
saving a record of the formatting formula corresponding to the user-edited value; and
apply the formatting formula corresponding to the corrected user-edited value to other values belonging to the category including the first value.

8. The system of claim 7, wherein the first value is one of a numeric value and a date representation.

9. The system of claim 7, wherein the processor is to further execute processor-executable instructions to cause the system to accept the indication of the correct choice for the user-edited value.

10. The system of claim 7, wherein the first value and the other values are derived from a database table.

11. The system of claim 7, wherein the category is one of a measure and a dimension of a database table.

12. The system of claim 7, wherein the processor is to further execute processor-executable instructions to cause the system to store the formatting formula in a memory store.

13. A non-transitory computer-readable medium storing program instructions executable by a processor of a computing system, the medium comprising:
instructions to present a first value to a user, the first value being a member of a category of values;
instructions to receive a user-edited value for displaying the first value in a desired format;
instructions to determine a best guess formatting formula corresponding to the user-edited value;
instructions to save a record of the formatting formula corresponding to the user-edited value; and
instructions to apply the formatting formula corresponding to the user-edited value to other values belonging to the category including the first value.

14. The medium of claim 13, wherein the first value is one of a numeric value and a date representation.

15. The medium of claim 13, further comprising instructions to receive, prior to the applying of the formatting formula, an indication of a user's acceptance of the formatting formula.

16. The medium of claim 13, wherein the first value and the other values are derived from a database table.

17. The medium of claim 13, wherein the category is one of a measure and a dimension of a database table.

18. The medium of claim 13, further comprising instructions to store the formatting formula in a memory store.
